(19) United States
(12) Patent Application Publication
(10) Pub. No.: US 2008/0234056 A1
(43) Pub. Date: Sep. 25, 2008

(54) Universal Joint System

(75) Inventor: Peter Grawenhof, Dettingen (DE)

Correspondence Address: BAKER & DANIELS LLP;111 E. WAYNE STREET, SUITE 800, FORT WAYNE, IN, 46802, US

(73) Assignee: VOITH TURBO GMBH & CO. KG, Heidenheim (DE)

(21) Appl. No.: 10/597,230

(22) PCT Filed: Jan. 20, 2005
(86) PCT No.: PCT/EP05/00508

§ 371 Date: Sep. 14, 2006

(30) Foreign Application Priority Data
Feb. 2, 2004 (DE) 10 2004 005 185.2
Apr. 7, 2004 (DE) 10 2004 017 104.1

(51) Int. Cl. F16D 3/38

(52) U.S. Cl. 464/135

(57) ABSTRACT

The invention relates to a universal joint system for use in cardan shafts, especially in heavy duty cardan shafts. Said universal joint system comprises a journal cross-assembly mounted in double yokes, the individual yoke comprising two yoke parts. Every yoke part comprises a base part and a bearing part, the yoke parts being positively interlinkable in the area of their base parts in coupling areas constituting coupling surfaces. The base parts of the yoke parts, on their coupling surface pointing to the base part of the respective other yoke part in the area of their outer periphery, have a first toothed section that is complementary thereto. The extensions of at least one tooth trace characterizing the first toothed section form an angle of >0° to <180° with a plane which is produced by the journal axis of the journal mounted in a yoke part and a yoke axis that is concurrent with a rotational axis of the yoke. In the area of the yoke axis, a second toothed section is provided at an angle to the first toothed section. According to the invention, the individual base part is configured as a full flange and joins the bearing part in a flush manner. The journal cross-assembly comprises two journal systems, offset from each other by 90°, and formed by two journals that are offset from each other by 180° and disposed on a common axis and in parallel planes. Every bearing part is provided with a blind bore for receiving the journals.

The present invention relates to a universal joint system, specifically having the features of the preamble of claim 1.

Universal joint systems for use in cardan shafts for different intended purposes are previously known in various embodiments from the prior art. These comprise a flange driver having two joint yoke halves and a journal cross. The flange drivers may in turn be implemented in different ways. In this case, embodiments of flange drivers in divided form in the area of the base part are previously known. Reference is made to the publications cited in the following as representatives:

1. EP 0 206 026 A1

2. DE 43 13 141 C2

3. DE 100 37 866 A1

These allow the design of one-piece and dimensionally stable bearing eyes, which remain a component of the adjoining yoke arm as in an undivided joint yoke, via which the force transmission to the bearing bore occurs. In this way, there is no interruption of the force flow to the specific most highly stressed parts of the joint yoke. The point of separation situated in the plane of symmetry between the bearing bore and the joint yoke is in the area of lower stress, which has hardly any influence on the force transmission. The systems offer the advantage of good embedding of the bearing in the bearing bore, very easy mounting, and an increase of the torque capacity and bearing carrying capacity. Simultaneously, joint yokes implemented as divided offer significant advantages in the unmachined part design and processing. In the embodiment described in EP 0 206 026 A1, the joint yoke halves each have a flange part which has formfitting elements on its side directed away from the journal cross axis, so that a formfitting connection is produced with the shaft which is driven or to be driven or the line shaft to be coupled to the joint yoke halves. In addition, removable connections are provided between the flange part and the particular attachment element, preferably in the form of a line shaft, for example, using anti-fatigue bolts. The coupling faces implemented on the joint yoke halves are situated essentially parallel to one another and have diametrically opposing wedge grooves in the middle area. Rectangular wedges are introduced into these wedge grooves. These are used above all to prevent shifting of the individual joint yoke halves toward one another parallel to the journal axis of the particular journal mounted in the joint yoke. Avoiding the relative movement of the joint yoke halves perpendicular to the journal axis may not be implemented using this achievement of the object. The joint yoke halves also may not be pre-tensioned against one another. In reversing operation in particular, individual areas of the joint yoke halves lift off at some points under the influence of the peripheral force. The lifting off causes a relative movement of the formfitting elements toward the recesses on the adjoining line shaft, which in turn results in the occurrence of cavities in which moisture and leakage water may collect. This results in the occurrence of corrosion which may also be forced by the micromovements of the joint yoke halves. This set of problems must be taken into consideration especially for use in heavy duty cardan shafts because of the higher peripheral forces. To achieve this object, according to DE 43 13 141 C2, an embodiment having front serrations on the flange bottom and teeth in the area of the partition faces is suggested to implement a formfitting connection between the two joint yoke halves. The teeth, which are preferably implemented as linear front teeth having diagonal flanks, are designed in such a way that the extensions of the flank lines of the teeth or, if spiral teeth are selected, the secants through both end points of the flank lines form an angle of >0° to <80° with a plane spanned by the joint axis and the journal axis. The joint axis is typically in the plane of symmetry between the two joint yoke halves and is perpendicular to the journal axis of the journal mounted in the joint yoke. The joint axis is understood in this case as the axis of rotation which is coincident with the axis of rotation of a cardan shaft. Through the clamping of the flanks, a relative movement between the joint yoke halves perpendicular to the journal axis is nearly precluded. However, the danger of small cracks on the tooth base after a long period of operation also exists in this embodiment. In particular in embodiments of flange drivers having closed bearing eyes, i.e., embodiments of the bearing parts having a blind bore for receiving the bearing system for the journal cross, which are intended for transmitting even higher torques, there is a special danger. Therefore, it is suggested in the publication DE 100 37 866 A1 that the teeth described from the publication DE 43 13 141 C2 only be situated in the radially external area of the coupling faces between the two joint yoke halves, in relation to the joint yoke axis, and further second teeth additionally be provided in the more strongly stressed areas, which is characterized in that the second teeth are oriented at an angle to the first teeth. This is preferably characterized in that the extension of one or more flank lines or—in an embodiment as spiral teeth—the extensions of a secant through the end points of the flank lines of the second teeth are situated at an angle between 70° and 110° to the extension of the flank lines of the first teeth. Preferably, the flank lines and/or their extensions and, with spiral teeth, the secants through the end points of the flank lines are oriented essentially perpendicular to the flank lines and/or the secants of the first teeth. Furthermore, means for clamping the two joint yoke halves against one another are provided.

Precisely in highly strained universal joint systems, as is the case for the use of heavy duty cardan shafts, for driving rolling mills, for example, it is especially important also to adapt the entire universal joint system in regard to its dimensioning and design to the load in order to achieve the highest possible service life. The cited measures on the coupling faces in regard to the connection to the attachment elements may be a component in this case, but are typically not sufficient, since precisely the highly loaded areas are to be designed correspondingly, which is in turn reflected in an enlargement of the overall space required, in particular in an enlargement of the universal joint diameter.

The present invention is thus based on the object of providing a universal joint system for use in cardan shafts, in particular heavy duty cardan shafts, which is characterized by a low overall space requirement in regard to the loads arising, and also by simple production and mounting. The optimization outlay is to be minimized as much as possible.

The achievement of the object according to the present invention is characterized by the features of claim 1. Advantageous embodiments are described in the subclaims.

According to the present invention, the universal joint system for use in cardan shafts, in particular heavy duty cardan shafts, is characterized by multiple features which allow especially advantageous properties in combination. The universal joint system comprises a journal cross which is mounted in two joint yokes situated 90° offset to one another. Each joint yoke comprises two joint yoke parts, each joint yoke part comprising a base part and a bearing part for receiving the mounting of the journals of the journal cross. The joint yoke parts are connectable to one another in a formfitting way in the area of their base parts in coupling areas, which form coupling faces. The base parts of the joint yoke parts have first teeth, which are complementary to one another, on their coupling faces pointing toward the base parts of the particular other joint yoke part in the area of the external circumference. The extension of at least one flank line characterizing the first teeth on the coupling faces or, with spiral teeth, the extension of the secants through the end points of the flank line form an angle of >0° to <180° with a plane which is formed by the journal axis of the journal mounted in the joint yoke part and a joint yoke axis coincident with an axis of rotation of the joint yoke. Moreover, further second teeth are provided on the coupling faces, which point toward one another, in the area of the joint yoke axis. These run at an angle to the first teeth. In particular, the extensions of the flank lines describing the orientation of the teeth or, with implementation as spiral teeth, the extension of a secant through the end points of a flank lines of the second teeth are situated at an angle between 70° and 110°, inclusive, to the extension of the flank lines to the first teeth or, with spiral teeth, to the extension of a secant through the end points of a flank lines of the first teeth. The individual face part is implemented according to the present invention as an integral flange and adjoins the bearing part without steps. It is thus possible to manufacture the individual joint yoke halves and/or the joint yoke as a cast part in an especially compact construction, free of undercuts or other steps. The most highly loaded areas are thus characterized by an appropriate material thickness, which results solely through the implementation as an integral flange, so that no additional measures are required in relation to the known joint yoke embodiments, but rather the positive properties are already provided here with the shaping. The proportion of the toothed area becomes larger and the means for clamping the two joint yoke parts of a joint yoke are laid in the center of gravity area of the teeth. The clamping in relation to the joint yoke axis G thus occurs in the radial direction, i.e., perpendicular thereto, and/or parallel to the journal axis of the journal mounted in the joint yoke. The means for clamping are then also situated in the areas designed later and are no longer, as in the related art having flange implementation, in the constricted and thus most highly loaded area. The means comprise coupling bolts in the simplest case. The coupling bolts in the center of the teeth cause, in relation to the embodiment from the prior art, a uniform load of the teeth and exploitation of the bolt capacity. With a diameter which remains uniform, the joint yoke halves thus designed may thus be loaded more.

There are manifold possibilities in regard to the orientation of the teeth. Preferably, the extensions of the flank lines of the first teeth or, with spiral teeth, the secants through the points of the flank lines are oriented running perpendicular to a plane which is formed by the journal axis of the journal mounted in the joint yoke and a joint yoke axis coincident with the axis of rotation of the joint yoke. Relative movements in the microrange may thus be prevented in these two directions to one another.

The journal cross itself comprises two journal systems, situated offset to one another by 90°, made of two journals situated offset to one another by 180° and on a shared axis, which are situated in planes parallel to one another. The mounting of the journals in the joint yoke halves is performed in the individual bearing parts of the joint yoke halves, these bearing parts being implemented with a blind bore to receive the journals. Overall space for an even stiffer bearing environment is opened up by the offset of the journal planes. This allows bearings and journal crosses to be implemented having even larger diameters. Furthermore, the yoke of the complementary flange driver, i.e., the joint yoke the particular other journal system of the journal cross, does not plunge so deep, so that in turn additional overall space for the teeth results. The axial offset of two journal systems in a universal joint yoke having journals situated offset in different planes, each two journals offset by 180° to one another forming a journal system and being characterized by a joint journal axis, is in the range from Rota/5 through Rota/7 inclusive, Rota characterizing the rotational diameter of the universal joint system. A stiff attachment construction is thus ensured for the mounting, which particularly meets the requirements for the transmission of very high torques and avoids as much as possible deformations precisely in the area of the bearing eyes, which have an especially disadvantageous effect on the carrying capacity of the bearings.

There are also multiple possibilities in regard to the concrete arrangement of the coupling faces, the coupling faces of the first and second teeth of each joint yoke part preferably being situated in a shared plane. However, an offset is also conceivable, i.e., an arrangement in planes parallel to one another or even in planes which occupy an angle. According to an especially advantageous embodiment, however, a variation having implementation of both sets of teeth on a joint yoke part in one plane is selected, since this achievement of the object is distinguished by the least manufacturing outlay.

Furthermore, according to the present invention, each individual face part carries, on the front side of the base part pointing away from the bearing part, means for coupling to complementary means on the attachment element for torque transmission to the attachment element and for centering of attachment element and joint yoke halves to avoid a relative movement in a plane which lies in the coupling area between the joint yoke halves and the attachment element and is oriented perpendicular to the plane which is formed by the journal axis of the journal mounted in the joint yoke part and the joint yoke axis coincident with the axis of rotation of the joint yoke. The means are implemented at least in segments over the entire circumference on the front side of the base part pointing away from the bearing part and comprise axially oriented front teeth running in the radial direction there. Furthermore, the means preferably comprise blind bores carrying threads on the base part, which are oriented parallel to the yoke axis. In addition, at least one connection means is provided for clamping the two joint yoke halves in the axial direction i.e., against one another. This extends through the integral flange. According to the present invention, the connection means are laid in the center of the second teeth, so that a uniform load of the teeth results especially advantageously upon clamping.

According to the present invention, the theoretical space available for torque transmission, which results through the contour of a universal joint system, is exploited optimally by implementation as a quasi-integral element. It is thus possible to transmit larger torques with uniform or higher service life using identical available overall space.

The achievement of the object according to the present invention is explained in the following on the basis of figures. Specifically, in the figures:

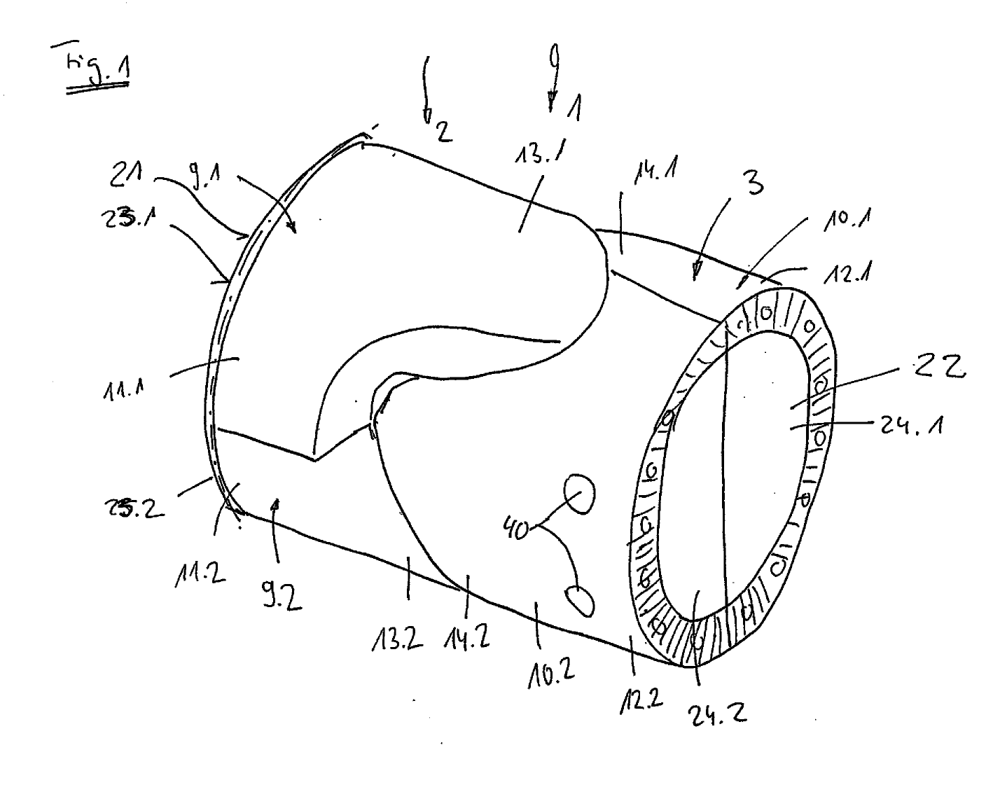

FIG. 1 shows a schematic, simplified illustration of the construction of the universal joint system designed according to the present invention for use in heavy duty cardan shafts;

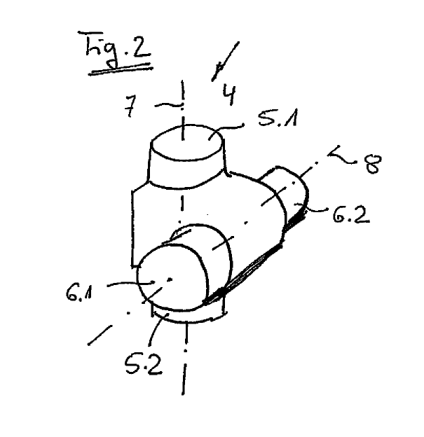

FIG. 2 shows the implementation of the journal cross designed according to the present invention;

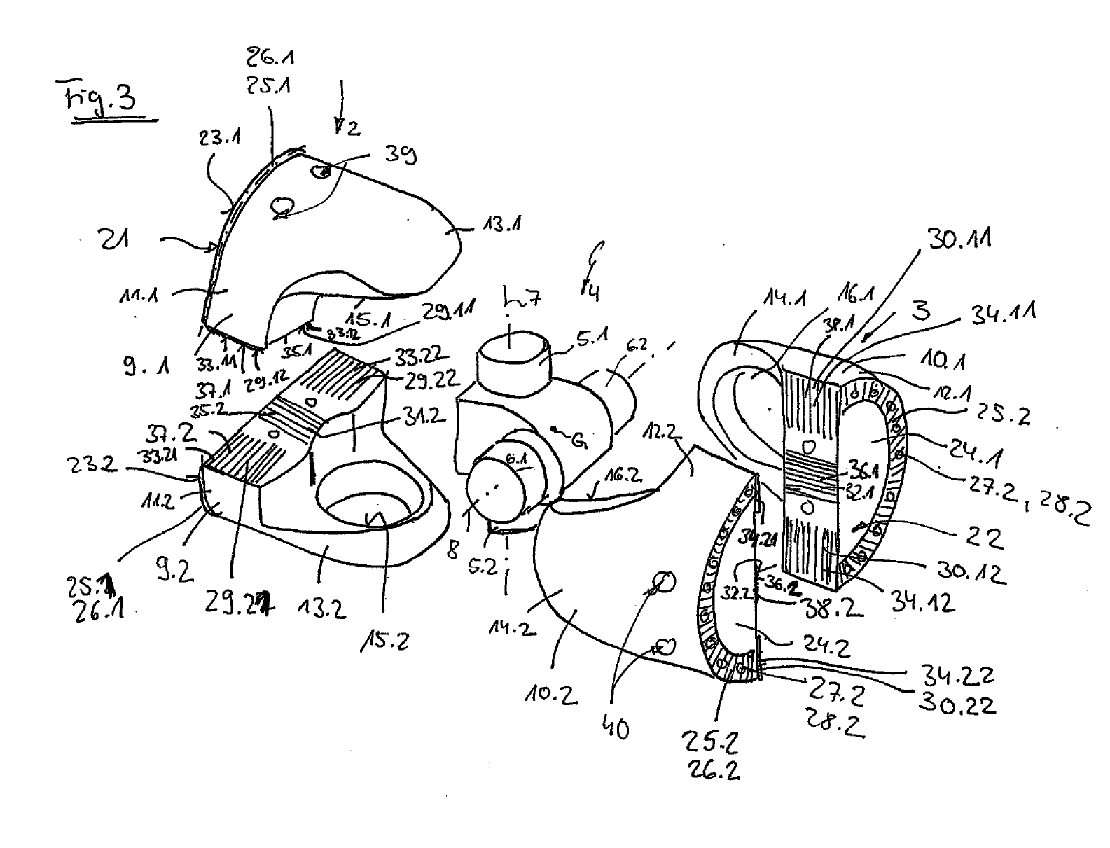

FIG. 3 shows the design shown in FIG. 1 in the disassembled state.

FIG. 1 shows a schematic, simplified illustration of the construction of a universal joint system 1 for use in heavy duty cardan shafts. This is reproduced in the disassembled state without the bearing system in FIG. 3. The universal joint system 1 comprises two joint yokes 2 and 3 situated offset by 90° to one another, which are used for mounting a journal cross 4. The journal cross 4 is implemented according to the present invention as a journal cross having journals situated in offset planes. The planes are situated parallel. The journal cross 4 is shown in a schematic, simplified illustration in FIG. 2. This comprises two journals 5.1, 5.2 and 6.1, 6.2 in each case, which are situated offset to one another by 180° and each form a journal system, both journals 5.1, 5.2 of a first journal system and 6.1, 6.2 of a second journal system being situated on a shared journal axis 7 or 8, respectively. The two journal axes 7 and 8 are situated offset by 90° to one another and are situated in parallel planes. The journal cross 4 may be implemented in one piece or may comprise two individual parts assembled with one another to form the structural unit of the journal cross 4, each individual part being characterized by a journal pair, situated on a journal axis 7 or 8 and forming the particular journal system, made of the journals 5.1, 5.2 or 6.1, 6.2, respectively. Furthermore, each joint yoke 2, 3 is implemented in a divided embodiment. These comprise two joint yoke parts 9.1, 9.2 for the joint yoke 2 and 10.1 and 10.2 for the joint yoke 3, preferably in the form of joint yoke halves. Each yoke part 9.1, 9.2 or 10.1, 10.3 [sic; 10.2] comprises a flange part 11.1 for the yoke part 9.1 and 11.2 for the yoke part 9.2 and 12.1 for the yoke part 10.1 and 12.2 for the yoke part 10.2. Bearing parts 13.1, 13.2, 14.1, 14.2 adjoin the flange parts 11.1, 11.2 and 12.1, 12.2, respectively. Each bearing part carries a blind bore 15.1 or 15.2 for mounting the journals 5.1 and 5.2 and 16.1, 16.2 for the journals 6.1, 6.2 of the journal cross 4. The flange parts 11.1, 11.2 and 12.1, 12.2 are implemented according to the present invention as an integral flange. This means that, in the area of the external diameter or in the area of the external circumference, the individual flange part 11.1, 11.2 or 12.1, 12.2 passes directly into the bearing part 13.1 or 13.2, respectively, without a step. A local constriction or step in relation to the bearing part 13.1, 13.2 or 14.1, 14.2 is not provided. The concrete embodiment in the disassembled state for the joint yoke 2 is shown in FIG. 3. The two yoke parts 9.1, 9.2, 10.1, 10.2, the flange parts 11.1, 11.2 and 12.1, 12.2 as well as the bearing parts 13.1, 13.2, 14.1, 14.2 connected thereto are shown therein. Furthermore, the blind bores 15.2, 16.1 for the bearing parts 13.2, 14.1 may be seen directly. Furthermore, it may be seen that in the disassembled state, the joint yoke 2 is implemented from the two yoke parts 9.1 and 9.2 and the joint yoke 3 is implemented from the yoke parts 10.1, 10.2. The partition preferably occurs in the area of the plane of symmetry between the two yoke parts 9.19.2 or 10.1, 10.2. These also form the connection or coupling areas 17, 18 for the yoke parts 9.19.2 or 10.1, 10.2 in each case, which are preferably characterized, with symmetrical implementation of the yoke parts 9.1, 9.2 and 10.1, 10.2, by a plane which may be described by two perpendicular lines to the journal axis 7 of the journals 5.1, 5.2 mounted in the joint yoke 2 or two perpendicular lines to the journal axis 8 of the journal 6.1, 6.2 mounted in the joint yoke 3. The connection plane is also characterized by the joint yoke axis G and a line perpendicular thereto. The two yoke parts 9.1 and 9.2 or 10.1 and 10.2 are connected in a formfitting way to one another in the coupling areas 17, 18, so that a relative movement in the direction parallel to the joint yoke axis G is avoided. The two flange parts 11.1 and 11.2 or 12.1, 12.2 form, in the assembled state while forming the joint yokes 2 or 3, a flange 19 or 20 which is used for attachment to torque-transmitting or relaying elements. This is connected to an attachment part on an adjoining shaft, which may lie both on the drive side and also on the output side. For the attachment, means 25.1, 25.2 for connection to an attachment element are assigned to the joint yokes 2 and 3 on the front side 21 or 22 directed toward the adjoining shaft, which are formed by the front sides 23.1, 23.2 and 24.1, 24.2 of the two flange parts 11.1, 11.2 and 12.1, 12.2 directed away from the bearing parts 13.1, 13.2 or 14.1, 14.2. These means may be implemented in many forms. In the simplest case, they are implemented as driver elements 26.1, 26.2 on the front sides 21 and 22, which allow a rotationally fixed connection around the circumference. Preferably, the driver elements 26.1, 26.2 are implemented as front serrations running in the radial direction and oriented in the axial direction. In interaction with front serrations situated complementarily thereto on the attachment part, these offer a frictional and self-centering connection. Furthermore, means 27.1, 27.2 for fixing in the axial direction, which connect the joint yoke 2 or 3 to the shafts to be attached, are assigned to the joint yoke parts 2, 3 and the attachment elements. In the simplest case, these comprise fasteners which are situated in blind bores 28.1, 28.2, which carry threads, on the front sides 21, 22 of the joint yokes 2, 3. According to the present invention, the two front sides 37.1, 37.2 and 38.1, 38.2, which point toward one another, and which are preferably oriented perpendicular to the plane spanned by the driver elements 26.1, 26.2 and characterize the plane of partition or the coupling areas 17, 18 between the two yoke parts 9.1, 9.2 and 10.1, 10.2, also carry first teeth 33.11, 33.12, 33.21, 33.22 or 34.11, 34.12, 34.21, 34.22. These teeth are each situated in the area of the external circumference of the yoke parts 9.1, 9.2, 10.1, 10.2 on the front sides 37.1, 37.2, 38.1, 38.2, which point toward one another, of the base parts 11.1, 11.2, 12.1, 12.2 and extend in the direction toward the joint yoke axis G. The first teeth 33.11, 33.12, 33.21, 33.22, 34.11, 34.12, 34.2.1, 34.22 are situated on first coupling faces 29.11, 29.12, 29.21, 29.22, 30.11, 30.12, 30.21, 30.22 on the front sides 37.1, 37.2 or 38.1, 38.2, which form partial faces thereof. The extensions of at least one flank line F_{L} characterizing these first teeth 33.11, 33.12, 33.21, 33.22, 34.11, 34.12, 34.21, 34.22 on the coupling faces 29.11, 29.12, 29.21, 29.22, 30.11, 30.12, 30.21, 30.21, 30.22 or, with implementation of these teeth as spiral teeth, the extension of the secants through the end points of the flank line F_{L}, form an angle of >0° to <180° with a plane which is formed by the journal axis 7 or 8 of the journal 5.1, 5.2 or 6.1, 6.2 mounted in the particular joint yoke parts 9.1, 9.2 or 10.1, 10.2 and a joint yoke axis G coincident with an axis of rotation of the joint yoke 2, 3. Preferably, the first teeth 33.11, 33.12, 33.21, 33.22, 34.11, 34.12, 34.21, 34.22 each run perpendicular thereto and are implemented as linear front teeth. The tooth size of these first teeth 33.11, 33.12, 33.21, 33.22, 34.11, 34.12, 34.21, 34.22 is preferably selected as equal to that of the front serrations on the bottom of the flange 19, 20. The use of identical tools may thus be ensured, which is reflected in more effective exploitation of the machinery already provided. Furthermore, to avoid micromovements between the individual joint yoke parts 9.1, 9.2 or 10.1, 10.2 in the coupling areas 17 or 18, further second teeth 35.1, 35.2 and 36.1, 36.2 are provided in each case on the coupling faces 31.1, 31.2 and 32.1, 32.2, which are situated between the first teeth 33.11 and 33.12 or 33.21 and 33.22 or 34.11 and 34.12 or 34.21 and 34.22 on each base part 11.1, 11.2, 12.1, and 12.2 and are oriented at an angle to the first teeth 33.11, 33.12, 33.21, 33.22, 34.11, 34.12, 34.21, 34.22. The extensions of the flank lines describing the orientation of the teeth 35.1, 35.2, 36.1, 36.2 or, with implementation as spiral teeth, the extensions of a secant through the end points of a flank line F_{L} of the second teeth 35.1, 35.2, 36.1, 36.2, are situated at an angle between 70° and 110°, inclusive, to the extension of a flank line of the first teeth 33.11, 33.12, 33.21, 33.22, 34.11, 34.12, 34.21, 34.22 or, with spiral teeth, to the extension of a secant through the end points of a flank line F_{L} of the first teeth 33.11, 33.12, 33.21, 33.22, 34.11, 34.12, 34.21, 34.22.

Furthermore, as already described, the individual yoke parts 9.1, 9.2, 10.1, 10.2 comprise a flange part 11.1, 11.2, 12.1, 12.2 and a bearing part 13.1, 13.2, 14.1, 14.2 which forms a unit with the flange part 11.1, 11.2, 12.1, 12.2 and carries the bearing bore in the form of the blind bore 15.1, 15.2, 16.1, 16.2. This ensures a stiff bearing attachment construction. The clamping of the two yoke parts 9.1 and 9.2 or 10.1, 10.2 against one another is typically performed by frictional connection elements 39, 40, formfitting elements also being conceivable. Bolt connections are preferably selected. This also applies analogously for the fastening of the individual joint yoke 2 to the attachment elements, in particular the adjoining shaft. At least one connection element of this type is provided. However, two are preferably selected per joint yoke. These are identified by 39.1, 39.2 for the through openings on the joint yoke 2 and 40.1, 40.2 on the joint yoke 3. According to the present invention, the connection elements are laid in the area of the center of gravity of the second teeth or are assigned to the flange symmetrically in the direction toward the external circumference thereof. Only thus, in connection with the implementation of the transition from the bearing part to the flange part free of constrictions, i.e., implementation of the joint yoke having an integral flange, does the possibility result of uniform load of the second teeth and also the first teeth.

The achievement of the object according to the present invention is characterized in that the overall space theoretically available for a universal joint system may be exploited completely in an especially optimal form here and, through a very compact construction, a suitability for heavy duty cardan shafts and thus for transmitting higher torques may be provided. Because of the implementation of the flange parts 11.1, 11.2 or 12.1 and 12.2 as integral flanges 19, 20 with a direct transition free of undercuts or steps to the bearing parts 13.1, 13.2, 14.1, 14.2, this embodiment is characterized by a low manufacturing outlay since this component may be produced simply. Furthermore, the implementation of the journal cross as the journal cross 4 having offset journals and the complementary teeth 22 in the planes of partition contributes thereto.

List of reference numbers

| | |
|---|---|
| 1 | universal joint system |
| 2 | joint yoke |
| 3 | joint yoke |
| 4 | journal cross |
| 5.1, 5.2 | journal |
| 6.1, 6.2 | journal |
| 7 | journal axis |
| 8 | journal axis |
| 9.1, 9.2 | yoke part |
| 10.1, 10.2 | yoke part |
| 11.1, 11.2 | flange part |
| 12.1, 12.2 | flange part |
| 13.1, 13.2 | bearing part |
| 14.1, 14.2 | bearing part |
| 15.1, 15.2 | blind bore |
| 16.1, 16.2 | blind bore |
| 17 | coupling area |
| 18 | coupling area |
| 19 | flange |
| 20 | flange |
| 21 | front side |
| 22 | front side |
| 22.1, 23.2 | front side |
| 24.1, 24.2 | front side |
| 25.1, 25.2 | means for implementing a torque transmission around the |
| | circumference |
| 26.1, 26.2 | driver elements |
| 27.1, 27.2 | means for axial fixing between attachment element and |
| | joint yoke |
| 28.1, 28.2 | means for axial fixing between attachment element and |
| | joint yoke |
| 29.11, 29.12 | |
| 29.21, 29.22 | coupling face |
| 30.11, 30.12 | |
| 30.21, 30.22 | coupling face |
| 31.1., 31.2 | coupling face |
| 32.1, 32.2 | coupling face |
| 33.11, 33.12 | first teeth |
| 33.21, 33.22 | first teeth |
| 34.11, 34.12 | first teeth |
| 34.21, 34.22 | first teeth |
| 35 | second teeth |
| 36 | second teeth |
| 37.1, 37.2 | front side |
| 38.1, 38.2 | front side |
| 39, 39.1, 39.2 | connection element |
| 40, 40.1, 40.2 | connection element |

1. A universal joint system (1) for use in cardan shafts, in particular heavy duty cardan shafts;
having a journal cross (4), which is mounted in two joint yokes (2, 3) situated offset by 90° to one another;
each joint yoke (2, 3) comprises two joint yoke parts (9.1, 9.2, 10.1, 10.2);
each joint yoke part (9.1, 9.2, 10.1, 10.2) comprises a base part (11.1, 11.2, 12.1, 12.2) and a bearing part (13.1, 13.2, 14.1, 14.2) for mounting the journals (5.1, 5.2, 6.1, 6.2) of a journal cross (4);
each individual face part (11.1, 11.2, 12.1, 12.2) carries, on the front side (21, 22) pointing away from the bearing part (13.1, 13.2, 14.1, 14.2), means for coupling with complementary means in the form of driver element (26.1, 26.2) on the attachment element;
the joint yoke parts (9.1, 9.2, 10.1, 10.2) have, in the area of their base parts (11.1, 11.2, 12.1, 12.2), coupling areas (17, 18) forming coupling faces (29.11, 29.12, 29.21, 29.22, 30.11, 30.12, 30.21, 30.22, 31.1, 31.2, 32.1, 32.2) which are connectable to one another in a formfitting way, the coupling areas (17, 18) being characterized by a plane which is oriented perpendicular to the plane spanned by the driver elements (26.1, 26.2);
the base parts. (11.1, 11.2, 12.1, 12.2) of the joint yoke parts (9.1, 9.2, 10.1, 10.2) have, on their coupling face (29.11, 29.12, 29.21, 29.22, 30.11, 30.12, 30.21, 30.22, 31.1, 31.2, 32.1, 32.2) pointing toward the base part (11.1, 11.2, 12.1, 12.2) of the particular other joint yoke part (10.1, 10.2, 9.1, 9.2), first teeth (33.11, 33.12, 33.21, 33.22, 34.11, 34.12, 34.21, 34.22) which are complementary to one another;
the extensions of at least one flank line (F_{L}) characterizing the first teeth (33.11, 33.12, 33.21, 33.22, 34.11, 34.12, 34.21, 34.22) on the coupling face or, with spiral teeth, the extension of the secants through the endpoints of the flank line (F_{L}) form an angle of >0° to <180° with a plane which is formed by the journal axis (7) of the journal (5.1, 5.2) mounted in a joint yoke part (9.1, 9.2, 10.1, 10.2) and a joint yoke axis (G) coincident with an axis of rotation of the joint yoke (2, 3);
having further second teeth (35.1, 35.2) implemented on each of the coupling faces pointing toward one another in the area of the joint yoke axis (G);
the extensions of the flank lines of the second teeth (35.1, 35.2) describing the orientation of the teeth or, with implementation as spiral teeth, the extension of a secant through the endpoints of a flank line (F_{L}) of the second teeth (35.1, 35.2) are situated at an angle between 70° and 110°, inclusive, to the extension of a flank line of the first teeth (33.11, 33.12, 33.21, 33.22, 34.11, 34.12, 34.21, 34.22) or, with spiral teeth, to the extension of a secant through the endpoints of a flank line (F_{L}) of the first teeth (33.11, 33.12, 33.21, 33.22, 34.11, 34.12, 34.21, 34.22);
the individual base part (9.1, 9.2, 10.1, 10.2) is implemented as an integral flange and adjoins the bearing part (11.1, 11.2, 12.1, 12.2) without steps;
the journal cross (4) comprises two journals systems situated 90° offset to one another made of two journals (5.1, 5.2, 6.1, 6.2) situated 180° offset to one another and situated on a shared axis, which are situated in planes parallel to one another;
each individual bearing part (13.1, 13.2, 14.1, 14.2) for receiving the journals (5.1, 5.2, 6.1, 6.2) is implemented having a blind bore (15.1, 15.2, 16.1, 16.2);
the joint yoke parts of a joint yoke are connected to one another in the area of the base part (11.1, 11.2, 12.1, 12.2) via connection elements, the connection elements extending through the base part in the area of the center of gravity of the second teeth.

2. The universal joint system (1) according to claim 1, characterized in that the individual coupling faces (29.11, 29.12, 29.21, 29.22, 30.11, 30.12, 30.21, 30.22, 31.1, 31.2, 32.1, 32.2), carrying the first (33.11, 33.12, 33.21, 33.22, 34.11, 34.12, 34.21, 34.22) and second teeth (35.1, 35.2, 36.1, 36.2), of each joint yoke part (9.1, 9.2, 10.1, 10.2) are situated in one plane.

3. The universal joint system (1) according to claim 1, characterized in that the individual coupling faces (29.11, 29.12, 29.21, 29.22, 30.11, 30.12, 30.21, 30.22, 31.1, 31.2, 32.1, 32.2) for the first (33.11, 33.12, 33.21, 33.22, 34.11, 34.12, 34.21, 34.22) and second teeth (35.1, 35.2, 36.1, 36.2) of each joint yoke part (9.1, 9.2, 10.1, 10.2) are situated in different planes.

4. The universal joint system (1) according to claim 1, characterized in that the extension of the flank lines (F_{L}) of the first teeth (33.11, 33.12, 33.21, 33.22, 34.11, 34.12, 34.21, 34.22) or, with spiral teeth, the secant through the endpoints of the flank line (F_{L}) run perpendicular to a plane which is characterized by the journal axis (7, 8) of the journal (5.1, 5.2, 6.1, 6.2) mounted in the joint yoke (2, 3) and a joint yoke axis (G) coincident with an axis of rotation of the joint yoke (2, 3).

5. The universal joint system (1) according to claim 1, characterized in that, on the front side (23.1, 23.2, 24.1, 24.2) of the base part (11.1, 11.2, 12.1, 12.2) pointing away from the bearing part (13.1, 13.2, 14.1, 14.2), means (25.1, 25.2, 26.1, 26.2, 27.1, 27.2, 28.1, 28.2) are provided for coupling with complementary means on an attachment element for torque transmission to the attachment element and for centering attachment element and base part (11.1, 11.2, 12.1, 12.2) to avoid a relative movement in a plane which characterizes the coupling area between joint yoke part (9.1, 9.2, 10.1, 10.2) and attachment element and is oriented perpendicular to the plane which is formed by the journal axis (7, 8) of the journal (5.1, 5.2, 6.1, 6.2) mounted in the joint yoke part (9.1, 9.2, 10.1, 10.2) and the joint yoke axis (G) coincident with the axis of rotation of the joint yoke (2, 3).

6. The universal joint system (1) according to claim 5, characterized in that the means (25.1, 25.2, 26.1, 26.2, 27.1, 27.2, 28.1, 28.2) comprise at least one axially oriented front teeth or front serrations implemented in at least segments over the entire circumference on the front side (23.1, 23.2, 24.1, 24.2) of the base part (11.1, 11.2, 12.1, 12.2) facing away from the bearing part (13.1, 13.2, 14.1, 14.2) and running in the radial direction.

7. The universal joint system (1) according to claim 5, characterized in that the means (25.1, 25.2, 26.1, 26.2, 27.1, 27.2, 28.1, 28.2) for coupling with complementary means on an attachment element (25) comprise blind bores (28.1, 28.2), carrying threads, on the base part (11.1, 11.2, 12.1, 12.2), which are oriented parallel to the joint axis (G).

8. The universal joint system (1) according to claim 1, characterized in that the extension of the flank lines (F_{L}) of the second teeth (31.1, 31.2, 32.1, 32.2) or, with spiral teeth, the secant through the endpoints of a flank line of the second teeth (31.1, 31.2, 32.1, 32.2) runs parallel to the joint yoke axis (G).

9. The universal joint system (1) according to claim 1, characterized in that a spacing of specific size, which is formed by a surface area implemented free of teeth, is provided in each case between the second teeth (31.1, 31.2, 32.1, 32.2) and the first teeth (33.11, 33.12, 33.21, 33.22, 34.11, 34.12, 34.21, 34.22) on the front side (37.1, 37.2, 38.1, 38.2).

10. The universal joint system (1) according to claim 1, characterized by the following features:
the second teeth (31.1, 31.2, 32.1, 32.2) on each joint yoke part (9.1, 9.2, 10.1, 10.2) comprise two sets of partial teeth—first partial teeth and second partial teeth;
the two sets of partial teeth are situated at a distance from the joint yoke axis (G).

11. The universal joint system (1) according to claim 1, characterized in that the axial offset of the individual journal axes of the journal system (5.1, 5.2, 6.1, 6.2) of the journal cross (4) mounted in a joint yoke are in a range of Rota/5 to Rota/7, inclusive, Rota characterizing the rotational diameter.

12. The universal joint system (1) according to claim 2, characterized in that the extension of the flank lines (F_{L}) of the first teeth (33.11, 33.12, 33.21, 33.22, 34.11, 34.12, 34.21, 34.22) or, with spiral teeth, the secant through the endpoints of the flank line (F_{L}) run perpendicular to a plane which is characterized by the journal axis (7, 8) of the journal (5.1, 5.2, 6.1, 6.2) mounted in the joint yoke (2, 3) and a joint yoke axis (G) coincident with an axis of rotation of the joint yoke (2, 3).

13. The universal joint system (1) according to claim 3, characterized in that the extension of the flank lines (F_{L}) of the first teeth (33.11, 33.12, 33.21, 33.22, 34.11, 34.12, 34.21, 34.22) or, with spiral teeth, the secant through the endpoints of the flank line (F_{L}) run perpendicular to a plane which is characterized by the journal axis (7, 8) of the journal (5.1, 5.2, 6.1, 6.2) mounted in the joint yoke (2, 3) and a joint yoke axis (G) coincident with an axis of rotation of the joint yoke (2, 3).

14. The universal joint system (1) according to claim 2, characterized in that, on the front side (23.1, 23.2, 24.1, 24.2) of the base part (11.1, 11.2, 12.1, 12.2) pointing away from the bearing part (13.1, 13.2, 14.1, 14.2), means (25.1, 25.2, 26.1, 26.2, 27.1, 27.2, 28.1, 28.2) are provided for coupling with complementary means on an attachment element for torque transmission to the attachment element and for centering attachment element and base part (11.1, 11.2, 12.1, 12.2) to avoid a relative movement in a plane which characterizes the coupling area between joint yoke part (9.1, 9.2, 10.1, 10.2) and attachment element and is oriented perpendicular to the plane which is formed by the journal axis (7, 8) of the journal (5.1, 5.2, 6.1, 6.2) mounted in the joint yoke part (9.1, 9.2, 10.1, 10.2) and the joint yoke axis (G) coincident with the axis of rotation of the joint yoke (2, 3).

15. The universal joint system (1) according to claim 3, characterized in that, on the front side (23.1, 23.2, 24.1, 24.2) of the base part (11.1, 11.2, 12.1, 12.2) pointing away from the bearing part (13.1, 13.2, 14.1, 14.2), means (25.1, 25.2, 26.1, 26.2, 27.1, 27.2, 28.1, 28.2) are provided for coupling with complementary means on an attachment element for torque transmission to the attachment element and for centering attachment element and base part (11.1, 11.2, 12.1, 12.2) to avoid a relative movement in a plane which characterizes the coupling area between joint yoke part (9.1, 9.2, 10.1, 10.2) and attachment element and is oriented perpendicular to the plane which is formed by the journal axis (7, 8) of the journal (5.1, 5.2, 6.1, 6.2) mounted in the joint yoke part (9.1, 9.2, 10.1, 10.2) and the joint yoke axis (G) coincident with the axis of rotation of the joint yoke (2, 3).

16. The universal joint system (1) according to claim 4, characterized in that, on the front side (23.1, 23.2, 24.1, 24.2) of the base part (11.1, 11.2, 12.1, 12.2) pointing away from the bearing part (13.1, 13.2, 14.1, 14.2), means (25.1, 25.2, 26.1, 26.2, 27.1, 27.2, 28.1, 28.2) are provided for coupling with complementary means on an attachment element for torque transmission to the attachment element and for centering attachment element and base part (11.1, 11.2, 12.1, 12.2) to avoid a relative movement in a plane which characterizes the coupling area between joint yoke part (9.1, 9.2, 10.1, 10.2) and attachment element and is oriented perpendicular to the plane which is formed by the journal axis (7, 8) of the journal (5.1, 5.2, 6.1, 6.2) mounted in the joint yoke part (9.1, 9.2, 10.1, 10.2) and the joint yoke axis (G) coincident with the axis of rotation of the joint yoke (2, 3).

17. The universal joint system (1) according to claim 6, characterized in that the means (25.1, 25.2, 26.1, 26.2, 27.1, 27.2, 28.1, 28.2) for coupling with complementary means on an attachment element (25) comprise blind bores (28.1, 28.2), carrying threads, on the base part (11.1, 11.2, 12.1, 12.2), which are oriented parallel to the joint axis (G).

18. The universal joint system (1) according to claim 2, characterized in that the extension of the flank lines (F_{L}) of the second teeth (31.1, 31.2, 32.1, 32.2) or, with spiral teeth, the secant through the endpoints of a flank line of the second teeth (31.1, 31.2, 32.1, 32.2) runs parallel to the joint yoke axis (G).

19. The universal joint system (1) according to claim 3, characterized in that the extension of the flank lines (F_{L}) of the second teeth (31.1, 31.2, 32.1, 32.2) or, with spiral teeth, the secant through the endpoints of a flank line of the second teeth (31.1, 31.2, 32.1, 32.2) runs parallel to the joint yoke axis (G).

20. The universal joint system (1) according to claim 4, characterized in that the extension of the flank lines (F_{L}) of the second teeth (31.1, 31.2, 32.1, 32.2) or, with spiral teeth, the secant through the endpoints of a flank line of the second teeth (31.1, 31.2, 32.1, 32.2) runs parallel to the joint yoke axis (G).
